(19) United States
(12) Patent Application Publication
(10) Pub. No.: US 2009/0286508 A1
(43) Pub. Date: Nov. 19, 2009

(54) PROVIDING A REAL-TIME COST OF A SESSION TO A USER

(76) Inventors: Yigang Cai, Naperville, IL (US); Shiyan Hua, Lisle, IL (US)

Correspondence Address: DUFT BORNSEN & FISHMAN, LLP, 1526 SPRUCE STREET, SUITE 302, BOULDER, CO, 80302, US

(21) Appl. No.: 12/121,314

(22) Filed: May 15, 2008

(51) Int. Cl. H04M 11/00

(52) U.S. Cl. 455/407

(57) ABSTRACT

Systems and methods are disclosed for providing a real-time cost for a session over a communication network to a user of a communication device. To provide the real-time cost, rate information for a session is determined, and the elapsed duration for the session is monitored. Based on the rate information and the elapsed duration, an estimated cost for the session may be determined. The estimated cost may then be displayed or otherwise provided to the user of the communication device so that the user is informed of the cost of the session as the session progresses. The rate information and an estimated account balance may also be provided to the user.

### BACKGROUND OF THE INVENTION

1. Field of the Invention

The invention is related to the field of communication networks, and in particular, to providing a real-time cost notification/indication for a session over a communication network to a user of a communication device.

2. Statement of the Problem

Service providers provide numerous voice and/or data services to users of a wireline or a wireless communication network. Exemplary services include telephony, access to the Internet, gaming, broadcasting or multicasting of audio, video, and multimedia programming, etc. The service providers use charging systems to keep track of the charges incurred by users for accessing the various services. Prepaid charging is generally defined as a charging mechanism where charging information can affect, in real-time, the service rendered, and therefore a direct interaction of the charging system with session/service control is needed. According to present prepaid mechanisms, the charging rate for a session (or call) is determined during set up of the session. For instance, if a communication device initiates a prepaid session, then a prepaid charging system in the network receives a charging request message from a network element before the session is authorized. The charging request message includes charging information, such as the calling party number, the called party number, the class of service for the calling party, etc. The prepaid charging system then determines a charging rate for the session based on this and other charging information. The charging rate is then used to determine the cost for the session. For example, if the charging rate is $0.05/minute, then the cost of the call will be the charging rate times the duration for the session. The cost per time unit is continually decremented from an account of the user as the session progresses.

Postpaid charging is generally defined as a charging mechanism where charging information does not affect, in real-time, the service rendered. In postpaid charging, charging information for network resource usage is collected concurrently with resource usage. At the end of the session, one or more Charging Data Records (CDRs) are sent to a postpaid charging system in the network. The postpaid charging system processes the charging information in the CDRs to determine a charging rate for the session and a total duration for the session. The charging rate and the total duration are then used to determine the cost for the session. The user is then billed for the session, such as in a monthly bill.

One problem is that the user does not know what the cost of a session is in real time as the session progresses. For prepaid sessions, the user is typically notified of the account balance that is available at the beginning of the session. Also, the user is notified when the account balance is running low, and is notified of the remaining account balance at the end of the session. However, there is presently no indication provided to the user during the session regarding the on-going cost of the session. For postpaid sessions, there is also no indication provided to the user during the session regarding the on-going cost of the session. The communication device of the user may monitor the duration of the session, and provide an indication of the elapsed duration to the user. However, the cost of the session is not provided to the user. The user may identify the cost of the session after the session is over, such as by accessing a web site for the service provider. However, there is presently no indication provided to the user during the session regarding the on-going cost of the session.

### SUMMARY OF THE SOLUTION

Embodiments of the invention solve the above and other related problems by providing a real-time cost for a session over a communication network to a user of a communication device. To provide the real-time cost, rate information for a session is determined, and the elapsed duration for the session is monitored. Based on the rate information and the elapsed duration, the real-time cost for the session may be determined. The real-time cost may then be displayed or otherwise provided to the user of the communication device so that the user can advantageously be informed of the cost of the session as the session progresses. The user may then be able to limit how much an individual session will cost and avoid high cost sessions. For example, an online gaming session may last several hours or even days. By providing a real-time cost, the user is aware of the present cost of the session so that he/she may end the session if the cost gets too high.

One embodiment of the invention comprises a system operable to provide a real-time cost for a session over a communication network. The system as provided herein may be implemented in the communication device of the user, in a network element in the communication network, or a combination of the two. The system includes a rating system operable to determine rate information for an on-going session involving the user. To determining the rate information, the system may query a charging system for the session. The system also includes a monitoring system operable to monitor an elapsed duration of the session. Based on the rate information and the elapsed duration, a cost determination system is operable to determine an estimated cost for the session. The system further includes a user interface system operable to provide the estimated cost for the session to the user. For example, the user interface system may display the estimated cost for the session to the user in real time so that the user is aware of the cost of the on-going session.

In another embodiment, the user interface system is further operable to provide the rate information to the user in addition to the estimated cost or as an alternative to the estimated cost.

In another embodiment, the rating system is further operable to determine account information for the user, such as a present balance for the user. The cost determination system is further operable to determine an estimated account balance based on the account information and the estimated cost for the session. The user interface system is further operable to provide the estimated account balance to the user. Once again, the user interface system may provide the estimated account balance to the user in addition to the estimated cost or as an alternative to the estimated cost.

The invention may include other exemplary embodiments described below.

### DESCRIPTION OF THE DRAWINGS

The same reference number represents the same element or same type of element on all drawings.

FIG. 1 illustrates a communication network in an exemplary embodiment of the invention.

FIG. 2 illustrates a system operable to provide a real-time cost for a session in an exemplary embodiment of the invention.

FIG. 3 is a flow chart illustrating a method of providing a real-time cost for a session to a user in an exemplary embodiment of the invention.

FIGS. 4-6 illustrate a communication device displaying estimated costs for a session in an exemplary embodiment of the invention.

FIG. 7 is a flow chart illustrating a method of providing real-time rate information for a session to a user in an exemplary embodiment of the invention.

FIG. 8 illustrates a communication device displaying rate information in an exemplary embodiment of the invention.

FIG. 9 is a flow chart illustrating a method of providing real-time account information to a user in an exemplary embodiment of the invention.

FIGS. 10-12 illustrate a communication device displaying estimated account balances in an exemplary embodiment of the invention.

FIG. 13 is a flow chart illustrating a method of handling a change to a charging rate in an exemplary embodiment of the invention.

FIG. 14 illustrates an IMS network in an exemplary embodiment of the invention.

FIG. 15 is a message diagram illustrating an example of providing a real-time cost of a session in an IMS network in an exemplary embodiment of the invention.

### DETAILED DESCRIPTION OF THE INVENTION

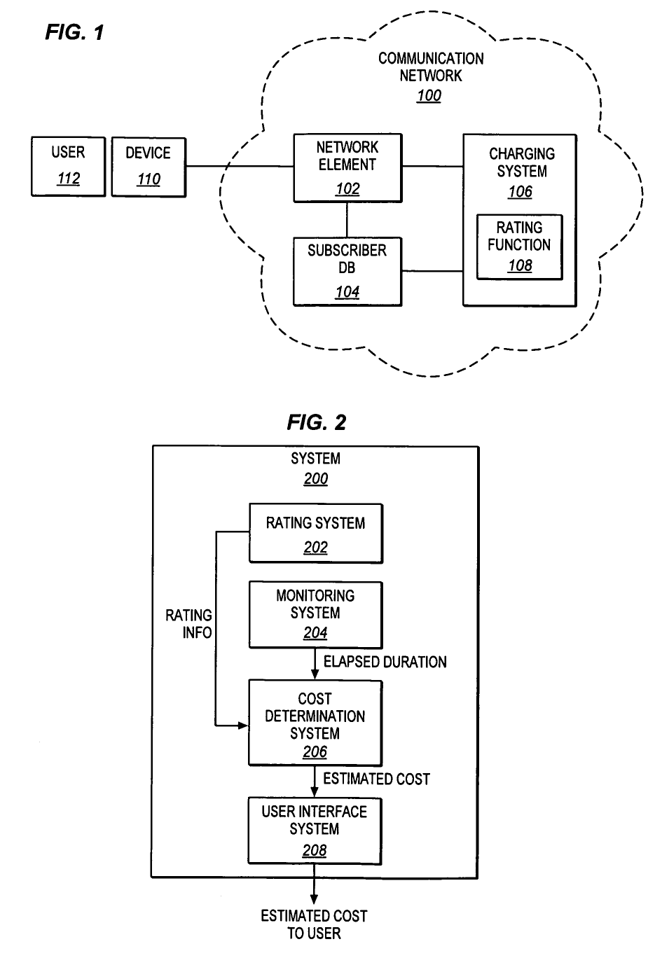

FIGS. 1-15 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 includes a network element 102, a subscriber database 104, and a charging system 106. Communication network 100 is operable to provide a communication service to a communication device 110 that is being operated by user 112. Communication network 100 may comprise a circuit-based network, a packet-based network, an IP Multimedia Subsystem (IMS), etc. Communication device 110 may access communication network 100 through a wired connection or through a wireless connection (e.g., a CDMA connection, a GSM connection, a WiFi/WiMAX connection, etc). Communication device 110 may comprise a handset, a PC, a PDA, or remote wireless or wireline terminals.

Network element 102 comprises any system, server, or function operable to provide a service or otherwise serve a session. For example, network element 102 may comprise a Mobile Switching Center (MSC) in a cellular network, may comprise a Serving-Call Session Control Function (S-CSCF) in an IMS network, a switch in a PSTN, etc.

Subscriber database 104 comprises any system, server, or function operable to store and maintain user profiles for user 112 and other users. The profile for user 112 includes a service plan subscribed to by user 112, which indicates the class of service for user 112, any supplementary services subscribed to by user 112, etc. Subscriber database 104 may comprise a Home Subscriber Server (HSS), a Home Location Register (HLR), or another database.

Charging system 106 comprises any system, server, or component operable to provide charging for sessions in communication network 100 and/or other communication networks. Charging system 106 may comprise a prepaid charging system or a postpaid charging system. Charging system 106 includes a rating function 108 that is operable to determine or define a charging rate for the session. To determine the charging rate, rating function 108 identifies a charging profile for user 112, such as by accessing the user profile from subscriber database 104. The charging profile for user 112 includes the charging rate for local outbound sessions, for national outbound sessions, for international outbound sessions, etc. The charging profile also includes the charging rate for airtime if user 112 is a mobile subscriber.

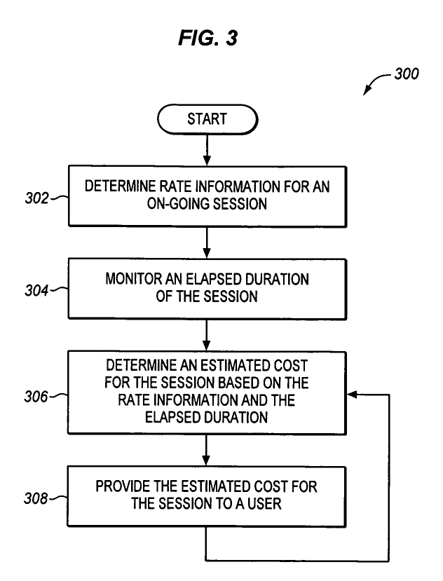

FIG. 2 illustrates a system 200 operable to provide a real-time cost for a session in an exemplary embodiment of the invention. System 200 includes a rating system 202, a monitoring system 204, a cost determination system 206, and a user interface system 208. Rating system 202 comprises any component or function operable to determine or identify rate information for a session. Monitoring system 204 comprises any component or function operable to monitor an elapsed duration of a session. Cost determination system 206 comprises any component or function operable to determine or calculate an estimated cost for a session based on an elapsed duration for the session, rate information for the session, and/or other information. User interface system 208 comprises any component or function operable to provide an estimated cost for a session to a user. User interface system 208 may be operable to display the estimated cost for a session, such as on a screen of a communication device. User interface system 208 may alternatively be operable to play an announcement of the estimated cost, such as through a speaker in a communication device. User interface system 208 may also or alternatively comprise any component or function operable to provide rate information for a session to a user, provide a remaining account balance to a user, or provide other information for a session to a user. System 200 may be implemented in communication device 110, in network element 102, and/or other systems not shown in FIG. 1.

Rating system 202, monitoring system 204, cost determination system 206, and user interface system 208 may be implemented in hardware, software, firmware, or any combination thereof to provide the desired operation. For example, systems 202-208 may be comprised of instructions that are stored on storage media. The instructions may be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accordance with the invention. Some examples of processing systems are computers, integrated circuits, and logic circuitry.

When in operation, assume that user 112 (see FIG. 1) initiates a session or is invited to a session through communication device 110. Network element 102 is serving the session, and charging system 106 is performing or will perform charging functions for the session. FIG. 3 is a flow chart illustrating a method 300 of providing a real-time cost for the session to user 112 in an exemplary embodiment of the invention. The steps of method 300 will be described with reference to communication network 100 in FIG. 1 and system 200 in FIG. 2, although the method may be performed by other types of communication networks and systems. The steps of the flow chart in FIG. 3 are not all inclusive and may include other steps not shown.

In step 302, rating system 202 determines rate information for the on-going session. Rating system 202 may determine the rate information in a variety of ways. In one example, rating system 202 may identify the charging system 106 for the session, and then transmit a query message to charging system 106 for the rate information for the session. The query message from rating system 202 includes an identifier for user 112 or communication device 110, such as a directory number, so that charging system 106 may identify a charging profile for user 112 that includes the rate information. Charging system 106 generates a response message that includes the rate information, and rating system 202 receives the response message from charging system 106. Rating system 202 may transmit the query message to charging system 106 upon initiation of the session, periodically based on a time interval, or according to some other desired sequence.

The rate information from charging system 106 may include a charging rate that has been or will be applied for the session. Alternatively, the rate information from charging system 106 may include a charging profile for user 112. The charging profile indicates how sessions are charged for user 112. For instance, the charging profile for user 112 may include the charging rate for local outbound sessions, for national outbound sessions, for international outbound sessions, etc. The charging profile may also include the charging rate for airtime for inbound sessions if user 112 is a mobile subscriber. In this case, system 200 determines the charging rate for the session instead of having charging system 106 determine the charging rate. To do so, rating system 202 processes the rate information to identify the charging profile for user 112, and selects a charging rate for the session from the charging profile. Rating system 202 may select the charging rate based on a variety of conditions for the session, such as the other party(ies) to the session, the media selected for the session, a level of Quality of Service (QoS), etc.

In step 304 of FIG. 3, monitoring system 204 monitors an elapsed duration of the session. Monitoring system 204 includes a counter, a timer, or some other component that begins at the initiation of the session, and counts the length of time for the session as the session progresses.

In step 306, cost determination system 206 determines an estimated cost for the session based on the rate information and the elapsed duration. Because the elapsed duration represents the time that has elapsed since initiation of the session, cost determination system 206 is able to use the elapsed duration and the rate information to calculate a real-time cost estimate for the session. For example, if the elapsed duration for the session is 10 minutes and the rate information indicates that the charging rate for this session is $0.10/minute, then the estimated cost for the session will be $1.00. The cost determined by cost determination system 206 is considered an “estimate” because it may differ slightly from the actual cost determined by charging system 106.

In step 308, user interface system 208 provides the estimated cost for the session to user 112. User interface system 208 may be operable to display the estimated cost to user 112, such as on a screen of communication device 110. User interface system 208 may alternatively be operable to play an announcement of the estimated cost, such as through a speaker in communication device 110. User interface system 208 may provide the estimated cost to user 112 in other desired ways.

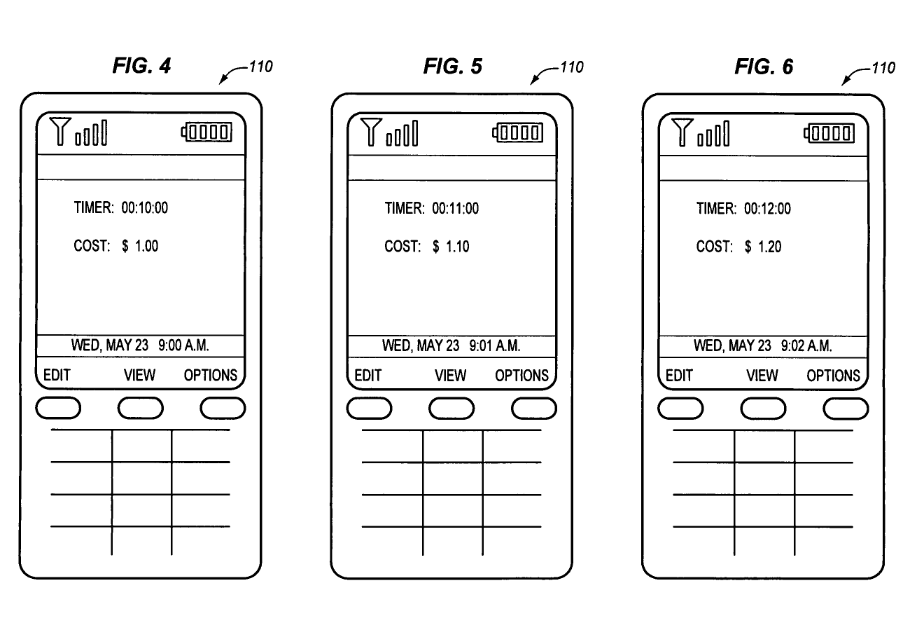

Cost determination system 206 iteratively determines the estimated cost for the session based on a time interval, such as every minute, every thirty seconds, etc. User interface system 208 will provide each iteration of the estimated cost to user 112 so that user 112 has a real-time estimate of the cost for the session. FIG. 4 illustrates communication device 110 displaying an estimated cost in an exemplary embodiment of the invention. Assume for this embodiment that the charging rate for this session is $0.10/minute, and that the elapsed duration for the session is 10 minutes. Cost determination system 206 thus calculates the estimated cost of the session to be $1.00. User interface system 208 displays this estimated cost to user 112 as is illustrated in FIG. 4.

At the next iteration (assume at the next minute), cost determination system 206 again determines the estimated cost for the session. The elapsed duration for the session is now 11 minutes. Based on the same charging rate of $0.10/minute applied with an elapsed duration of 11 minutes, cost determination system 206 calculates the estimated cost of the session to be $1.10. User interface system 208 displays this estimated cost to user 112 as is illustrated in FIG. 5.

At the next iteration (assume again at the next minute), cost determination system 206 determines the estimated cost for the session. The elapsed duration for the session is now 12 minutes. Based on the same charging rate of $0.10/minute applied with an elapsed duration of 12 minutes, cost determination system 206 calculates the estimated cost of the session to be $1.20. User interface system 208 displays this estimated cost to user 112 as is illustrated in FIG. 6. This process continues for the duration of the session so that user 112 is continually informed of the real-time cost of the session.

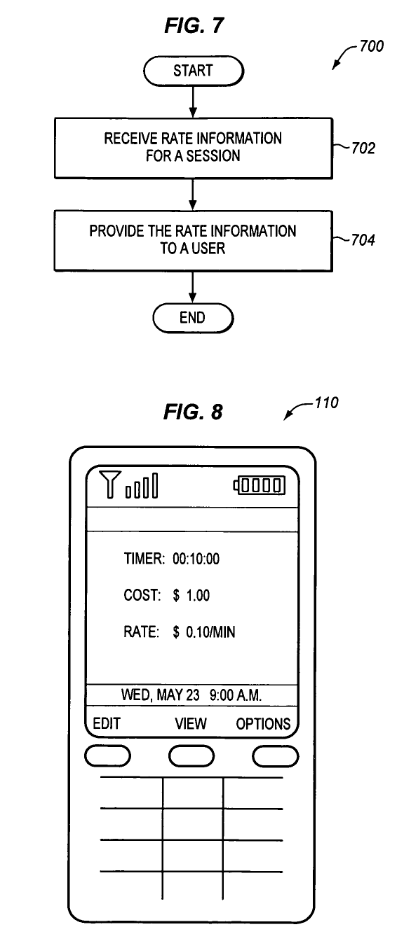

In addition to or as an alternative to providing the estimated cost to user 112, user interface system 208 may provide rate information to user 112. FIG. 7 is a flow chart illustrating a method 700 of providing real-time rate information for the session to user 112 in an exemplary embodiment of the invention. In step 702, user interface system 208 receives the rate information for the session from rating system 202 or cost determination system 206. One assumption is that rating system 202 has already determined the rate information for the session, such as by querying charging system 106. The rate information may indicate, for instance, that user 112 is being charged $0.10/minute for the session. In step 704, user interface system 208 provides (e.g., displays) the rate information to user 112.

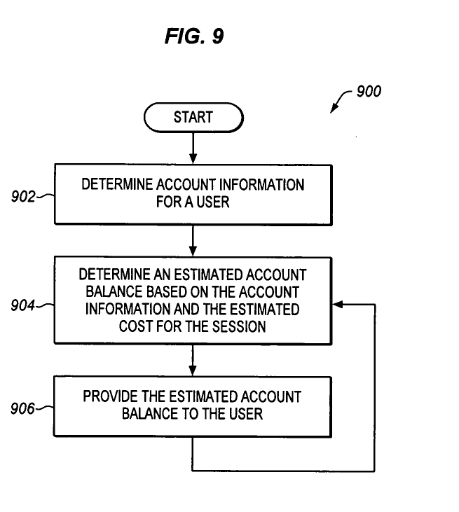

FIG. 8 illustrates communication device 110 displaying rate information in an exemplary embodiment of the invention. In this embodiment, user interface system 208 displays the rate information along with the estimated cost for the session. In other embodiments, user interface system 208 may display the rate information instead of the estimated cost.

In addition to or as an alternative to providing the estimated cost to user 112, user interface system 208 may provide account information to user 112. FIG. 9 is a flow chart illustrating a method 900 of providing real-time account information to user 112 in an exemplary embodiment of the invention. In step 902, rating system 202 determines account information for user 112. The account information may include an indication of the balance in the account of a user, such as for a prepaid session. To determine the account information, rating system 202 may identify the charging system 106 for the session, and then transmit a query message to charging system 106 for the account information for the session. The query message from rating system 202 includes an identifier for user 112 or communication device 110, such as a directory number, so that charging system 106 may identify an account for user 112. Charging system 106 generates a response message that includes the account information, and rating system 202 receives the response message from charging system 106.

In step 904, cost determination system 208 determines an estimated account balance for user 112 based on the account information and the estimated cost for the session. For example, if the account information indicates that user 112 initially has $10.00 in his/her account, and the present estimated cost for the session is $1.00, then the present estimated account balance for user 112 would be $9.00. In step 906, user interface system 208 provides (e.g., displays) the estimated account balance to user 112.

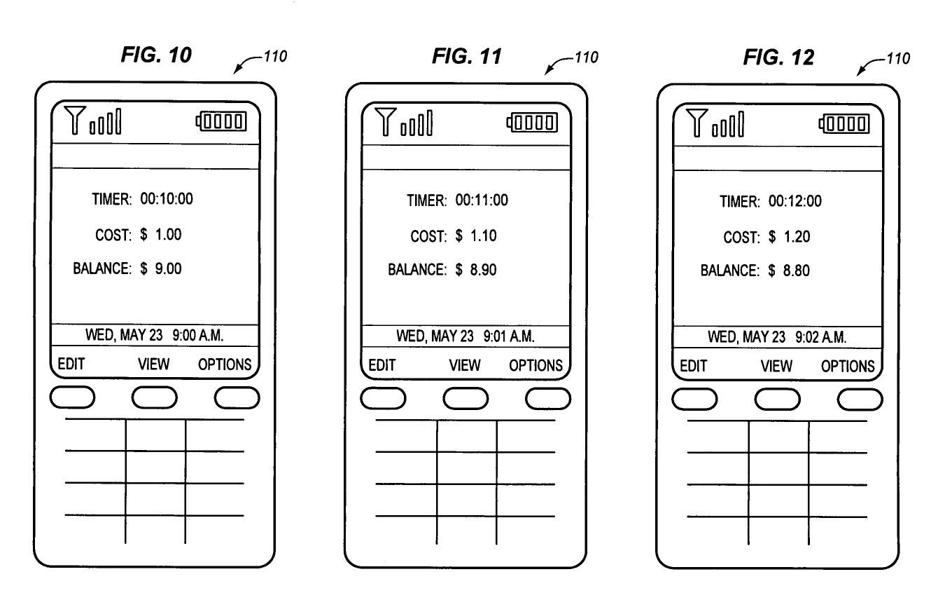

Cost determination system 206 iteratively determines the estimated account balance for the session based on a time interval, such as every minute, every thirty seconds, etc. User interface system 208 will provide each iteration of the estimated account balance to user 112 so that user 112 has a real-time estimate of his/her account balance for the session. FIG. 10 illustrates communication device 110 displaying an estimated account balance in an exemplary embodiment of the invention. Assume for this embodiment that the charging rate for this session is $0.10/minute, that the elapsed duration for the session is 10 minutes, and that the initial account balance for user 112 was $10.00. Cost determination system 206 thus calculates the estimated cost of the session to be $1.00, and subtracts this cost from the initial account balance so that the present estimated account balance is $9.00. User interface system 208 displays this estimated account balance to user 112 as is illustrated in FIG. 10.

At the next iteration (assume at the next minute), cost determination system 206 again determines the estimated account balance for the session. The elapsed duration for the session is now 11 minutes. Based on the same charging rate of $0.10/minute applied with an elapsed duration of 11 minutes, cost determination system 206 calculates the estimated cost of the session to be $1.10 and the estimated account balance to be $8.90. User interface system 208 displays this estimated account balance to user 112 as is illustrated in FIG. 11.

At the next iteration (assume again at the next minute), cost determination system 206 determines the estimated account balance for the session. The elapsed duration for the session is now 12 minutes. Based on the same charging rate of $0.10/minute applied with an elapsed duration of 12 minutes, cost determination system 206 calculates the estimated cost of the session to be $1.20 and the estimated account balance to be $8.80. User interface system 208 displays this estimated account balance to user 112 as is illustrated in FIG. 12. This process continues for the duration of the session so that user 112 is continually informed of his/her real-time account balance.

In the embodiment illustrated in FIGS. 10-12, user interface system 208 displays the estimated account balance along with the estimated cost for the session. In other embodiments, user interface system 208 may display the estimated account balance instead of the estimated cost.

The charging rate that is applied by charging system 106 may change during the session. For example, if a stepped charging rate is used (e.g., $0.05 for the first ten minutes, $0.10 for the next 10 minutes, and $0.20 for the remainder of the session), then the charging rate will change as the session progresses. Also, one or more conditions may change during the session which in turn affects the charging rate for the session. For example, a change to the charging rate may be triggered by a media change during the session, by the session changing from a two-party session to a multi-party session, by a request for a new service during the session, by requesting a higher level of QoS, etc. Also, the charging rate may change from free to a particular toll during the session, or vice versa. When the charging rate changes during the session, rating system 202 operates as follows to handle the rate change.

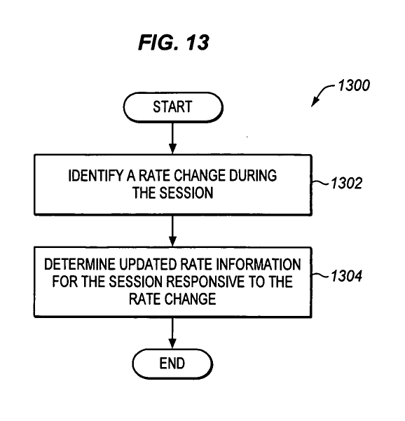

FIG. 13 is a flow chart illustrating a method 1300 of handling a change to a charging rate in an exemplary embodiment of the invention. The steps of method 1300 will be described with reference to communication network 100 in FIG. 1 and system 200 in FIG. 2, although the method may be performed by other types of communication networks and systems. The steps of the flow chart in FIG. 13 are not all inclusive and may include other steps not shown.

In step 1302, rating system 202 identifies a rate change during the session. To identify the rate change, rating system 202 may detect one or more of the triggers described above, and consequently identify the change to the charging rate. Alternatively, rating system 202 may request that charging system 106 inform it of any changes to the charging rate for the session. To do so, rating system 202 may transmit a request message (i.e., a SIP SUBSCRIBE) to charging system 106 to be notified of a rate change for the session. When charging system 106 detects the rate change, charging system 106 generates a notification message (i.e., a SIP NOTIFY) indicating an updated charging rate for the session. Rating system 202 then receives the notification message from charging system 106, which indicates a change to the charging rate.

In step 1304, rating system 202 determines updated rate information for the session responsive to the rate change. If rating system 202 has a charging profile for user 112, then rating system 202 may determine the updated rate information from the charging profile based on the new conditions for the session (e.g., based on a new media description for the session). Alternatively, rating system 202 may process the notification message from charging system 106 to identify the updated rate information as provided by charging system 106. After the updated rate information is determined responsive to the rate change, cost determination system 206 determines the estimated cost for the session based on the elapsed duration and the updated rate information, and user interface system 208 provides the estimated cost to user 112.

Rating system 202 may also report the updated rate information to user interface system 208. User interface system 208 may then provide (e.g., display) the updated rate information to user 112 along with the estimated cost for the session.

### EXAMPLE

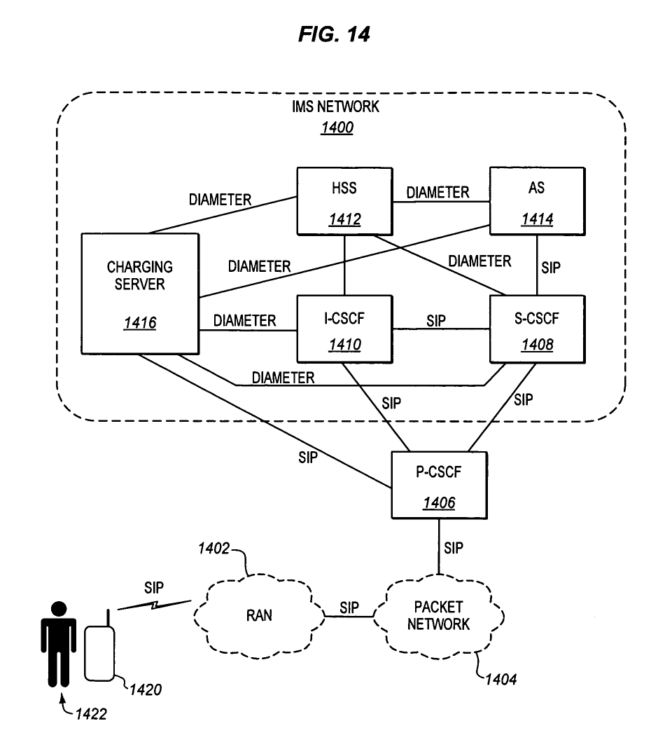

FIG. 14 illustrates an IMS network 1400 in an exemplary embodiment of the invention. IMS network 1400 illustrates the home network for a user 1422 that is operating a mobile device 1420. IMS network 1400 includes a Radio Access Network (RAN) 1402, a packet network 1404, a P-CSCF 1406, an S-CSCF 1408, an I-CSCF 1410, a Home Subscriber Server (HSS) 1412, an application server (AS) 1414, and a charging server 1416. Charging server 1416 may represent an Online Charging System (OCS) or an Offline Charging System (OFCS) in IMS network 1400. IMS network 1400 may include other nodes that are not illustrated in FIG. 14 for the sake of brevity.

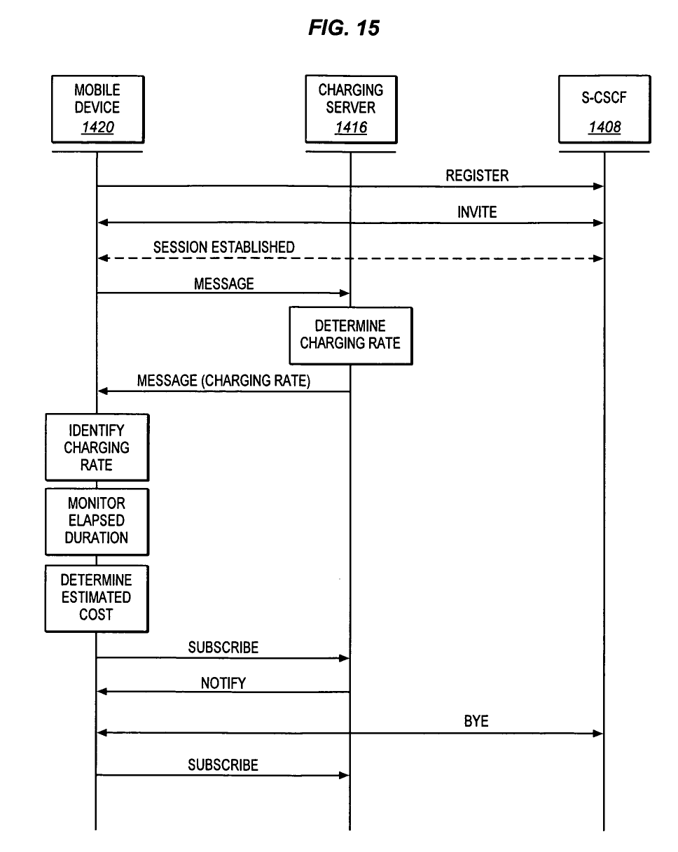

FIG. 15 is a message diagram illustrating an example of providing a real-time cost of a session in IMS network 1400 in an exemplary embodiment of the invention. The message diagram illustrates SIP messaging used within IMS network 1400, although other messaging protocols may be used in other embodiments.

To begin, mobile device 1420 transmits a SIP REGISTER to S-CSCF 1408 to register for service in IMS network 1400. When registered, assume that mobile device 1420 either transmits a SIP INVITE to S-CSCF 1408 or receives a SIP INVITE from S-CSCF 1408 to initiate a session. The session is then established for mobile device 1420 over IMS network 1400. With the session established, mobile device 1420 transmits a SIP MESSAGE to charging server 1416 requesting the present charging rate for the session involving user 1422. A rating function (not shown) in charging server 1416 determines the charging rate for the session, and charging server 1416 transmits a SIP MESSAGE response that includes the present charging rate for the session. Mobile device 1420 then processes the SIP MESSAGE from charging server 1416 to identify the present charging rate for the session.

From the time that the session is established, mobile device 1420 is continually monitoring an elapsed duration of the session. When mobile device 1420 identifies the present charging rate for the session, mobile device 1420 determines an estimated cost for the session based on the present charging rate and the elapsed duration for the session. Mobile device 1420 then provides (e.g., displays or announces) the estimated cost for the session to user 1422. This is an iterative process where mobile device 1420 continually updates the estimated cost for the session as the elapsed duration for the session increases. In other embodiments, mobile device 1420 may provide the charging rate for the session, may provide an estimated account balance for user 1422, or provide other information.

User 1422 may set a variety of settings for providing the estimated cost. For instance, user 1422 may set the time interval in which mobile device 1420 updates the estimated cost. The updates may be every minute, every thirty seconds, every five minutes, etc. User 1422 may also designate that the estimated cost is not provided until the cost reaches a threshold value, such as $5.00, $10.00, etc. User 1422 may also request that a warning is provided if the estimated cost reaches a maximum value, such as $10.00, $20.00, etc.

Mobile device 1420 also transmits a SIP SUBSCRIBE to charging server 1416 requesting to be notified if a rate change applies for the session involving user 1422. Charging server 1416 then monitors whether a rate change occurs for the session. The rate change may occur for a variety of reasons, such as a media change for the session (i.e., a voice session to a voice and data session), a change from a two party call to a multi-party call, a new service is requested for the session, a higher level of service is requested for the session, etc. If a rate change occurs, charging server 1416 generates a SIP NOTIFY which includes the updated charging rate for the session, and transmits the SIP NOTIFY to mobile device 1420. Responsive to receiving the SIP NOTIFY, mobile device 1420 determines the estimated cost for the session based on the elapsed duration and the updated charging rate.

When the session ends, mobile device 1420 either transmits a SIP BYE to S-CSCF 1408 or receives a SIP BYE from S-CSCF 1408 which terminates the session. When the session is terminated, mobile device 1420 transmits a SIP SUBSCRIBE to charging server 1416 to instruct charging server 1416 that notification of rate changes for the session are no longer needed.

In the embodiment provided above, mobile device 1420 communicates with charging server 1416 using SIP messaging. In an alternative embodiment, S-CSCF 1408 may act as an interface between mobile device 1420 and charging server 1416. To do so, mobile device 1420 communicates with S-CSCF 1408 using SIP messaging, and S-CSCF 1408 communicates with charging server 1416 through Diameter protocol.

Although specific embodiments were described herein, the scope of the invention is not limited to those specific embodiments. The scope of the invention is defined by the following claims and any equivalents thereof.

We claim:

1. A method of providing a real-time cost for a session over a communication network, the method comprising:
determining rate information for an on-going session involving a user;
monitoring an elapsed duration of the session;
determining an estimated cost for the session based on the rate information and the elapsed duration; and
providing the estimated cost for the session to the user.

2. The method of claim 1 wherein determining rate information comprises:
identifying a charging system for the session;
transmitting a query message to the charging system for the rate information for the session; and
receiving a response message from the charging system that includes the rate information.

3. The method of claim 2 further comprising:
transmitting the query message to the charging system upon initiation of the session.

4. The method of claim 2 further comprising:
processing the rate information to identify a charging profile for the user;
selecting a charging rate for the session from the charging profile; and
determining the estimated cost for the session based on the elapsed duration and the selected charging rate from the charging profile.

5. The method of claim 1 further comprising:
identifying a rate change during the session;
determining updated rate information for the session based on the rate change; and
determining the estimated cost for the session based on the elapsed duration and the updated rate information.

6. The method of claim 1 further comprising:
providing the rate information for the session to the user.

7. The method of claim 1 further comprising:
determining account information for the user;
determining an estimated account balance based on the account information and the estimated cost for the session; and
providing the estimated account balance to the user.

8. A system operable to provide a real-time cost for a session over a communication network, the system comprising:
a rating system operable to determine rate information for an on-going session involving a user;
a monitoring system operable to monitor an elapsed duration of the session;
a cost determination system operable to determine an estimated cost for the session based on the rate information and the elapsed duration; and
a user interface system operable to provide the estimated cost for the session to the user.

9. The system of claim 8 wherein:
the rating system is further operable to identify a charging system for the session, to transmit a query message to the charging system for the rate information for the session, and to receive a response message from the charging system that includes the rate information.

10. The system of claim 9 wherein:
the rating system is further operable to transmit the query message to the charging system upon initiation of the session.

11. The system of claim 9 wherein:
the rating system is further operable to process the rate information to identify a charging profile for the user, and to select a charging rate for the session from the charging profile; and
the cost determination system is further operable to determine the estimated cost for the session based on the elapsed duration and the selected charging rate from the charging profile.

12. The system of claim 8 wherein:
the rating system is further operable to identify a rate change during the session, and to determine updated rate information for the session based on the rate change; and
the cost determination system is further operable to determine the estimated cost for the session based on the elapsed duration and the updated rate information.

13. The system of claim 8 wherein:
the user interface system is further operable to receive the rate information from the rating system, and to provide the rate information to the user.

14. The system of claim 8 wherein:
the rating system is further operable to determine account information for the user;
the cost determination system is further operable to determine an estimated account balance based on the account information and the estimated cost; and
the user interface system is further operable to provide the estimated account balance to the user.

15. A communication device operable to provide a real-time cost for a session over a communication network, the communication device comprising:
a rating system operable to transmit a query message to a charging system requesting a charging rate for a session, and to receive a response message from the charging system that includes the charging rate;
a monitoring system operable to monitor an elapsed duration of the session;
a cost determination system operable to determine an estimated cost for the session based on the charging rate and the elapsed duration; and
a user interface system operable to provide the estimated cost for the session to a user of the communication device.

16. The communication device of claim 15 wherein:
the cost determination system is further operable to iteratively determine the estimated cost for the session based on the charging rate and the elapsed duration based on a time interval.

17. The communication device of claim 15 wherein:
the query message comprises a SIP MESSAGE.

18. The communication device of claim 15 wherein:
the rating system is further operable to transmit a request message to the charging system to be notified of a rate change for the session, and to receive a notification message from the charging system indicating an updated charging rate for the session.

19. The communication device of claim 18 wherein:
the cost determination system is further operable to determine the estimated cost for the session based on the updated charging rate and the elapsed duration.

20. The communication device of claim 18 wherein:
the request message comprises a SIP SUBSCRIBE; and
the notification message comprises a SIP NOTIFY.
